(19) United States
(12) Patent Application Publication
(10) Pub. No.: US 2016/0299881 A1
(43) Pub. Date: Oct. 13, 2016

(54) METHOD AND SYSTEM FOR SUMMARIZING A DOCUMENT

(71) Applicants: XEROX CORPORATION, Norwalk, CT (US); NETAJI SUBHASH INSTITUTE OF TECHNOLOGY (NSIT), New Delhi (IN)

(72) Inventors: Anand Gupta, New Delhi (IN); Manpreet Kaur, Greater Faridabad (IN); Shachar Mirkin, Meylan (FR)

(21) Appl. No.: 14/680,096

(22) Filed: Apr. 7, 2015

(51) Int. Cl. G06F 17/24; G06F 17/28

(52) U.S. Cl. CPC G06F 17/24; G06F 17/28

(57) ABSTRACT

The disclosed embodiments illustrate methods and systems for summarizing an electronic document. The method includes extracting, by a natural language processor, one or more sentences from said electronic document. The method further includes creating a graph, comprising one or more nodes and one or more edges connecting said one or more nodes, each node being representative of a sentence. An edge is placed between a pair of sentences based on a threshold value and a first score. The first score corresponds to a measure of an entailment between said pair of sentences. Thereafter, the method includes identifying a set of nodes from said one or more nodes by applying a minimum vertex cover algorithm on said graph. The sentences associated with said identified set of nodes are utilizable to create a summary of said electronic document. The method is performed by one or more microprocessors.

### TECHNICAL FIELD

The presently disclosed embodiments are related, in general, to document processing. More particularly, the presently disclosed embodiments are related to methods and systems for summarizing an electronic document.

### BACKGROUND

A document usually includes one or more sentences that are arranged in a predetermined manner so that a person reading through the document may be able to understand the context of the document. Some of the documents are very extensive and reading through the document, to understand the context, may be a time consuming task. Therefore, summarizing the document involves identifying a set of sentences from the document such that the set of sentences may allow a reader to understand the context of the document without going through the complete document.

### SUMMARY

According to embodiments illustrated herein, there is provided a method for summarizing an electronic document. The method includes extracting, by a natural language processor, one or more sentences from said electronic document. The method further includes creating a graph, comprising one or more nodes and one or more edges connecting said one or more nodes, each node being representative of a sentence from said one or more sentences. An edge is placed between a pair of sentences based on a threshold value and a first score. The first score corresponds to a measure of an entailment between said pair of sentences. Thereafter, the method includes identifying a set of nodes from said one or more nodes by applying a minimum vertex cover algorithm on said graph. The sentences associated with said identified set of nodes are utilizable to create a summary of said electronic document. The method is performed by one or more microprocessors.

According to embodiments illustrated herein, there is provided a method for summarizing an electronic document. The method includes extracting, by a natural language processor, one or more sentences from said electronic document. The method includes segregating, by said natural language processor, said one or more sentences into one or more segments. The method further includes determining a first score between each pair of said one or more segments by utilizing a textual entailment algorithm. The first score corresponds to a measure of entailment between each pair of said one or more segments. The method further includes determining a second score for each of said one or more sentences based on said determined first score of said one or more segments, respectively. Further, the method includes creating a graph, comprising one or more nodes and one or more edges connecting said one or more nodes, each node being representative of a sentence from said one or more sentences. An edge is placed between a pair of sentences based on a threshold value and said first score associated with said pair of segments. The threshold value is determined based on said second score associated with each of said one or more sentences. Thereafter, the method includes identifying a set of nodes from said one or more nodes by applying a minimum vertex cover algorithm on said graph. The sentences associated with said identified set of nodes are utilizable to create a summary of said electronic document. The method is performed by one or more microprocessors.

According to embodiments illustrated herein, there is provided a system for summarizing an electronic document. The system includes a natural language processor configured to extract one or more sentences from said electronic document. The system includes one or more microprocessors configured to create a graph, comprising one or more nodes and one or more edges connecting said one or more nodes, each node being representative of a sentence. An edge is placed between a pair of sentences based on a threshold value and a first score. The first score corresponds to a measure of an entailment between said pair of sentences. Thereafter, the system includes one or more microprocessors configured to identify a set of nodes from said one or more nodes by applying a minimum vertex cover algorithm on said graph. The sentences associated with said identified set of nodes are utilizable to create a summary of said electronic document.

According to embodiments illustrated herein, there is provided a system for summarizing an electronic document. The system includes a natural language processor configured to extract one or more sentences from said electronic document. The system further includes a natural language processor configured to segregate said one or more sentences into one or more segments. The system includes one or more microprocessors configured to determine a first score between each pair of said one or more segments by utilizing a textual entailment algorithm. The first score corresponds to a measure of entailment between each pair of said one or more segments. The system includes one or more microprocessors configured to determine a second score for each of said one or more sentences based on said determined first score of said one or more segments, respectively. The system includes one or more microprocessors configured to create a graph, comprising one or more nodes and one or more edges connecting said one or more nodes, each node being representative of a sentence. An edge is placed between a pair of sentences based on a threshold value and said first score associated with said pair of segments. The threshold value is determined based on said second score associated with each of said one or more sentences. Thereafter, the system includes one or more microprocessors configured to identify a set of nodes from said one or more nodes by applying a minimum vertex cover algorithm on said graph. The sentences associated with said identified set of nodes are utilizable to create a summary of said electronic document.

According to embodiments illustrated herein, there is provided a computer program product for use with a computing device. The computer program product comprises a non-transitory computer readable medium, the non-transitory computer readable medium stores a computer program code for summarizing an electronic document. The computer program code is executable by a natural language processor to extract one or more sentences from said electronic document. The computer program code is executable by one or more microprocessors to create a graph, comprising one or more nodes and one or more edges connecting said one or more nodes, each node being representative of a sentence from said one or more sentences. An edge is place between a pair of sentences based on a threshold value and a first score. The first score corresponds to a measure of an entailment between said pair of sentences. Thereafter, the computer program code is further executable by one or more microprocessors to identify a set of nodes from said one or more nodes by applying a minimum vertex cover algorithm on said graph. The sentences associated with said identified set of nodes are utilizable to create a summary of said electronic document.

According to embodiments illustrated herein, there is provided a computer program product for use with a computing device. The computer program product comprises a non-transitory computer readable medium, the non-transitory computer readable medium stores a computer program code for summarizing an electronic document. The computer program code is executable by a natural language processor to extract one or more sentences from said electronic document. The computer program code is further executable by said natural language processor to segregate said one or more sentences into one or more segments. The computer program code is executable by one or more microprocessors to determine a first score between each pair of said one or more segments by utilizing a textual entailment algorithm. The first score corresponds to a measure of entailment between each pair of said one or more segments. The computer program code is further executable by one or more microprocessors to determine a second score for each of said one or more sentences based on said determined first score of said one or more segments respectively. The computer program code is further executable by said one or more microprocessors to create a graph, comprising one or more nodes and one or more edges connecting said one or more nodes, each node being representative of a sentence from said one or more sentences. An edge is placed between a pair of sentences based on a threshold value and said first score associated with said pair of segments. The threshold value is determined based on said second score associated with each of said one or more sentences. Thereafter, the computer program code is further executable by said one or more microprocessors to identify a set of nodes from said one or more nodes by applying a minimum vertex cover algorithm on said graph. The sentences associated with said identified set of nodes are utilizable to create a summary of said electronic document.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram that illustrates a computing device for summarizing an electronic document, in accordance with at least one embodiment;

FIG. 3 is a message flow diagram illustrating flow of message/data between various components of the system environment, in accordance with at least one embodiment;

FIG. 4 is a flowchart illustrating a method for summarizing an electronic document, in accordance with at least one embodiment;

FIG. 5 is graph illustrating a method for creating a summary of an electronic document, in accordance with at least one embodiment; and

FIG. 6 is another flowchart illustrating another method for summarizing an electronic document, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the meanings set forth below.

A “document” refers to a collection of content, where the content may correspond to image content, or text content retained in at least one of an electronic form or a printed form. Each of the electronic form or the printed form may include one or more pictures, symbols, text, line art, blank, or non-printed regions, etc. The text content may include one or more sentences that are arranged in such a predetermined manner.

An “electronic document” refers to a digitized copy of the document. In an embodiment, the electronic document is obtained by scanning the document using a scanner, a multifunctional device (MFD), or other similar devices. The electronic document can be stored in various file formats, such as, JPG or JPEG, GIF, TIFF, PNG, BMP, RAW, PSD, PSP, PDF, and the like.

A “text” refers to letters, numerals, or symbols within the document. In an embodiment, the text may include words, phrases, sentences, or segments.

“Entailment” refers to a relationship between a pair of texts in the electronic document. The relationship may be representative of a concept of a text from the pair of texts being implicitly or explicitly implied from the other text in the pair of texts. In an embodiment, the texts may correspond to a sentence, phrase, or segment. However, the scope of the disclosure is not limited to text as a sentence, a phrase or a segment. Further, for the purpose of ongoing description, the text has been considered as a sentence/segment. For example, in a scenario, there may exist a possibility that a second sentence may be entailed by a first sentence, however, the first sentence may not be entailed by the second sentence. That is, the first sentence may be implied from the second sentence, however, the vice versa may not be true. Therefore, in such a scenario, the entailment score between the first sentence and the second sentence may not be zero, however, the entailment score between the second sentence and the first sentence may be zero. For example, the first score between the sentences S1 and S2 is 0. However, the first score between the sentences S2 and S1 is 0.02. Therefore, implying or deriving S2 from S1 is not possible, however, the vice versa may be true.

A “graph” refers to a representation that includes one or more nodes and one or more edges. In an embodiment, the one or more nodes may be used for representing one or more sentences in the electronic document. Further, the graph may include one or more edges connecting the one or more nodes. The one or more edges may represent a relationship between the one or more sentences.

A “sentence” is a collection of one or more words. In an embodiment, the sentence may include the one or more words grouped meaningfully to express a statement, question, exclamation, request, command, or suggestion.

“First Score” refers to a measure of an entailment between a pair of texts of the electronic document. In an embodiment, the first score may be determined between each pair of one or more segments of a sentence of the electronic document by utilizing a textual entailment algorithm.

“Second Score” refers to a measure of connectivity of a sentence with other sentences in the electronic document. In an embodiment, the second score for each of the one or more sentences may be determined based on the first score.

“Weight” refers to a score assigned to each of the one or more sentences in the electronic document. In an embodiment, the weights are assigned in such a manner that the second score remains positive. In an embodiment, the weight of each of the one or more sentences may be determined by utilizing the second score associated with each of the one or more sentences.

A “threshold value” refers to a value that may be utilized to add an edge between a pair of nodes (representing a pair of sentences) in the graph. In an embodiment, the threshold value may be determined based at least on the mean of the first score associated with each pair of the sentences in the electronic document. In another embodiment, the threshold value may be determined based on a word limit specified by a user for generating the required summary of the electronic document.

A “summary” refers to a gist of the document that may be utilized by a reader to understand the context of the document without going through the complete document. In an embodiment, the summary may be created by identifying a set of sentences from the document that briefly illustrates the context of the document.

A “segment” refers to a portion of a sentence. In an embodiment, the sentence may be segregated into one or more segments by utilizing one or more rules. The one or more rules may include, but not limited to, redact interrogative sentences, sentences with conjugation words, or sentences with examples. For example, if the sentence is “Russia would come to the aid of France if they were attacked by Germany, or by Italy supported by Germany; likewise, France would come to the aid of Russia if they were attacked by Germany”. Here, if “likewise” is removed, the first segment is “Russia would come to the aid of France if they were attacked by Germany, or by Italy supported by Germany” and the second segment is “France would come to the aid of Russia if they were attacked by Germany”.

A “word limit” refers to a limit of a number of words in the summary. In an embodiment, the word limit may be specified by the user. In an embodiment, the specified word limit of the summary may be utilized to determine the threshold value.

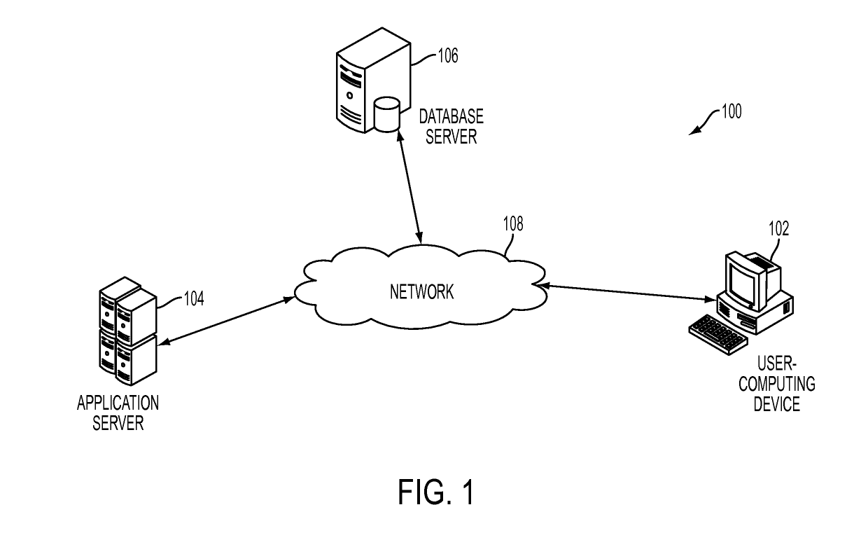

FIG. 1 is a block diagram illustrating a system environment 100 in which various embodiments may be implemented. The system environment 100 includes a user-computing device 102, an application server 104, a database server 106, and a network 108. Various devices in the system environment 100 (e.g., the user-computing device 102, the application server 104, and the database server 106) may be interconnected over the network 108.

The user-computing device 102 may refer to a computing device, used by a user, to view the summary of the electronic document. In an embodiment, the user-computing device 102 includes one or more processors, and one or more memories that are used to store instructions that are executable by a processor to perform predetermined operation. In an embodiment, the user-computing device 102 may provide a document, which has to be summarized, to the application server 104. In an embodiment, the user computing device 102 may scan the document to generate an electronic document. In an embodiment, the user-computing device 102 may have an attached image capturing device that may be used to convert the document into the electronic document. Thereafter, the user-computing device 102 may transmit the electronic document to the application server 104. In an embodiment, the user-computing device 102 may store the electronic document in the database server 106. In an embodiment; the user-computing device 102 may receive the summary from the application server 104. Further, the user-computing device 102 may present a user interface to the user. In an embodiment, the user interface may be reserved for the display of the summary of the electronic document. The user may utilize the user-computing device 102 to provide an input indicative of a word limit of the required summary of the electronic document.

The user-computing device 102 may be realized through a variety of computing devices, such as a desktop, a computer server, a laptop, a personal digital assistant (PDA), a tablet computer, and the like.

The application server 104 may refer to a computing device configured to create the summary of the electronic document. In an embodiment, the application server 104 may receive the electronic document from the user-computing device 102. In an embodiment, the application server 104 may extract one or more sentences from the received electronic document. Post extraction of the one or more sentences, the application server 102 may determine a first score for each pair of sentences. In an embodiment, the first score may correspond to a measure of entailment between the sentences in the pair of sentences. Further, in an embodiment, the application server 104 may determine a second score for each of the one or more sentences based on the determined first score. Based on the determined second score, the application server 104 may determine a weight for each sentence. In an embodiment, the application server 104 may create a graph to represent the one or more sentences. The graph may include one or more nodes and one or more edges connecting the one or more nodes. Each node may indicate a sentence from one or more sentences. Further, the application server 104 may add an edge between a pair of sentences based on a threshold value and the determined first score. Based on the created graph, the application server 104 may identify a set of nodes from the one or more nodes by applying an algorithm for finding a minimum vertex cover. Thereafter, the application server 104 may create the summary of the electronic document based on the identified set of nodes. In an embodiment, the application server 104 may send the summary to the user-computing device 102, where the user-computing device 102 may display the summary to the user over a display screen associated with the user-computing device 102.

In another embodiment, the application server 104 may segregate each of the extracted one or more sentences into one or more segments. In an embodiment, the application server 104 may determine a first score for each pair of the one or more segments. Based on the determined first score of the one or more segments, the application server 104 may determine a second score for each of the sentences from which the one or more segments were extracted. Further, the application server 104 may follow the same steps, as described above to create the summary of the electronic document.

In an embodiment, the application server 104 may receive an input from the user (using the user-computing device 102). The input may indicate a word limit of the required summary of the electronic document. Based on the specified word limit, the application server 104 may determine a threshold value.

The application server 104 may be realized through various types of application servers such as, but not limited to, Microsoft SQL Server®, Java application server, .NET framework, Base4, Oracle®, and MySQL®.

A person skilled in the art would appreciate that the scope of the disclosure is not limited to the application server 104 and the user-computing device 102 being separate entities. In an embodiment, the application server 104 may correspond to an application hosted on or running on the user-computing device 102 without departing from the spirit of the disclosure.

The database server 106 may refer to a device or a computer that maintains a repository of documents. Further, the database server 106 may store the threshold value associated with the electronic document. The database server 106 may store the input received from the user (utilizing the user-computing device 102), specifying the required word limit for the summary of the electronic document. In an embodiment, the database server 106 may store the summarized electronic document generated by the application server 104. The database server 106 may be implemented using technologies including, but not limited to, Oracle®, IBM DB2®, Microsoft SQL Server®, Microsoft Access®, PostgreSQL®, MySQL® and SQLite®, and the like. In an embodiment, the user-computing device 102 and/or the application server 104 may connect to the database server 106 using one or more protocols such as, but not limited to, ODBC protocol and JDBC protocol.

It will be apparent to a person skilled in the art that the functionalities of the database server 106 may be incorporated into the application server 104, without departing from the scope of the disclosure.

The network 108 corresponds to a medium through which content and messages flow between various devices of the system environment 100 (e.g., the user-computing device 102, the application server 104, and the database server 106). Examples of the network 108 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

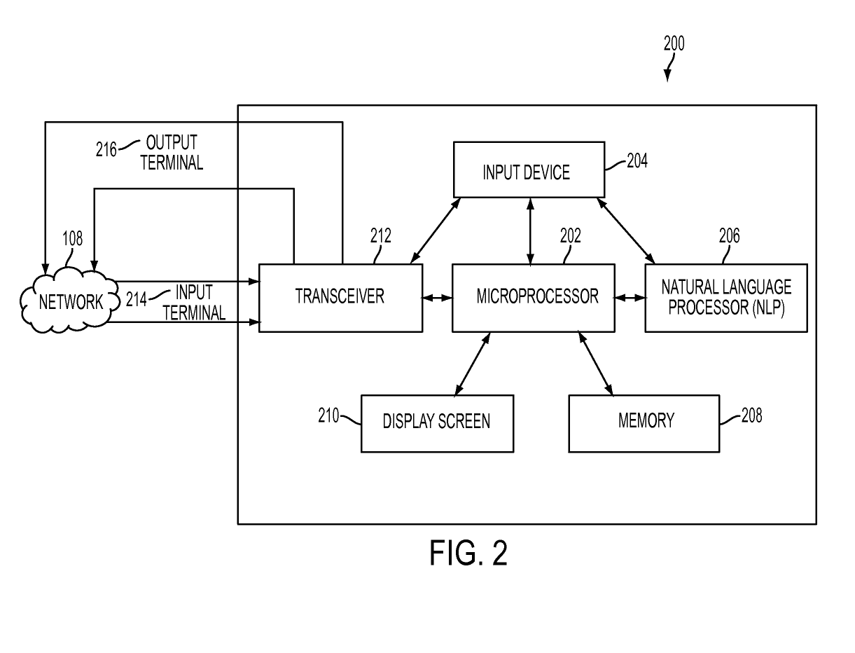

FIG. 2 is a block diagram that illustrates a computing device 200 for summarizing a document, in accordance with at least one embodiment. For the purpose of the ongoing disclosure, the computing device 200 has been considered as the application server 104. However, the scope of the disclosure should not be limited to the computing device 200 as the application server 104. The computing device 200 can also be realized as the user-computing device 102.

The application server 104 includes a microprocessor 202, an input device 204, a natural language processor 206, a memory 208, a display screen 210, a transceiver 212, an input terminal 214, and an output terminal 216. The microprocessor 202 is coupled to the input device 204, the natural language processor 206, the memory 208, the display screen 210, and the transceiver 212. The transceiver 212 may connect to the network 108 through the input terminal 214 and the output terminal 216.

The microprocessor 202 includes suitable logic, circuitry, and/or interfaces that are operable to execute one or more instructions stored in the memory 208 to perform predetermined operations. The microprocessor 202 may be implemented using one or more processor technologies known in the art. Examples of the microprocessor 202 include, but are not limited to, an x86 microprocessor, an ARM microprocessor, a Reduced Instruction Set Computing (RISC) microprocessor, an Application Specific Integrated Circuit (ASIC) microprocessor, a Complex Instruction Set Computing (CISC) microprocessor, or any other microprocessor.

The input device 204 may comprise suitable logic, circuitry, interfaces, and/or code that may be operable to receive an input from the user. The input device 204 may be operable to communicate with the microprocessor 202. Examples of the input devices may include, but are not limited to, a touch screen, a keyboard, a mouse, a joystick, a microphone, a camera, a motion sensor, a light sensor, and/or a docking station.

The natural language processor 206 is a microprocessor configured to analyze natural language content to draw meaningful conclusions there from. In an embodiment, the NLP 206 may employ one or more natural language processing and one or more machine learning techniques known in the art to perform the analysis of the natural language content. Examples of such techniques include, but are not limited to, Naïve Bayes classification, artificial neural networks, Support Vector Machines (SVM), multinomial logistic regression, or Gaussian Mixture Model (GMM) with Maximum Likelihood Estimation (MLE). Though the NLP 206 is depicted as separate from the microprocessor 202 in FIG. 2, a person skilled in the art would appreciate that the functionalities of the NLP 206 may be implemented within the microprocessor 202 without departing from the scope of the disclosure. In an embodiment, the NLP 206 may be implemented on an Application specific integrated circuit (ASIC), System on Chip (SoC), Field Programmable Gate Array (FPGA), etc.

The memory 208 stores a set of instructions and data. Some of the commonly known memory implementations include, but are not limited to, a random access memory (RAM), a read only memory (ROM), a hard disk drive (HDD), and a secure digital (SD) card. Further, the memory 208 includes the one or more instructions that are executable by the microprocessor 202 to perform specific operations. It is apparent to a person with ordinary skills in the art that the one or more instructions stored in the memory 208 enable the hardware of the system 200 to perform the predetermined operations.

The display screen 210 may comprise suitable logic, circuitry, interfaces, and/or code that may be operable to render a user interface. In an embodiment, the display screen 210 may be realized through several known technologies such as, but not limited to, Cathode Ray Tube (CRT) based display, Liquid Crystal Display (LCD), Light Emitting Diode (LED) based display, Organic LED display technology, and Retina display technology. It may be apparent to a person skilled in the art that the display screen 210 may be a part of the user-computing device 102. In such type of scenario, the display screen 210 may be capable of receiving input from the user of the user-computing device 102. The input may indicate a word limit for the required summary of the electronic document. In such a scenario, the display screen 210 may be a touch screen that enables the user to provide input. In an embodiment, the touch screen may correspond to at least one of a resistive touch screen, capacitive touch screen, or a thermal touch screen. In an embodiment, the display screen 210 may receive input through a virtual keypad, a stylus, a gesture, and/or touch based input.

The transceiver 212 transmits and receives messages and data to/from various components of the system environment 100 (e.g., the user-computing device 102 and the database server 106) over the network 108. In an embodiment, the transceiver 212 is coupled to the input terminal 214 and the output terminal 216 through which the transceiver 212 may receive and transmit data/messages respectively. Examples of the input terminal 214 and the output terminal 216 include, but are not limited to, an antenna, an Ethernet port, a USB port, or any other port that can be configured to receive and transmit data. The transceiver 212 transmits and receives data/messages in accordance with the various communication protocols such as, TCP/IP, UDP, and 2G, 3G, or 4G communication protocols through the input terminal 214 and the output terminal 216.

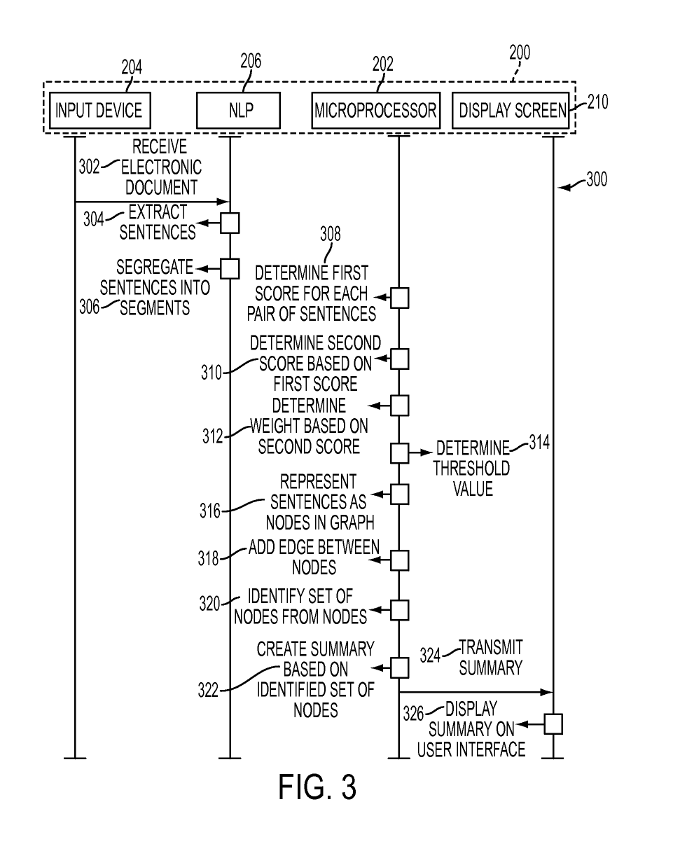

The operation of the system 200 has been described later in conjunction with FIG. 3.

FIG. 3 is a message flow diagram 300 illustrating flows of message/data between various components of the system 200, in accordance with at least one embodiment.

As shown in the FIG. 3, the input device 204 may send the electronic document to the NLP 206 for analysis (depicted by 302). Prior to sending the electronic document to the NLP 206, the transceiver 212 may receive the electronic document from the user-computing device 102 through the input terminal 214. In an embodiment, the user-computing device 102 may have sent the electronic document to the application server 104. Thereafter, the transceiver 212 may send the electronic document to the NLP 206 for analysis.

The NLP 206 may analyze the received electronic document by utilizing the one or more natural language processing techniques to extract one or more sentences from the electronic document (depicted by 304). Further, the NLP 206 may send the one or more sentences to the microprocessor 202 (not shown in FIG. 3).

In an alternate embodiment, the NLP 206 may segregate each of the one or more sentences into one or more segments (depicted by 306). In an embodiment, the NLP 206 may utilize the one or more natural language processing techniques to segregate each of the one or more sentences.

Further, based on the extracted sentences from the document, the microprocessor 202 may determine the first score for every pair of sentences (depicted by 308). The first score corresponds to a measure of entailment between the sentences in the pair of sentences of the electronic document. Further, the microprocessor 202 may determine the second score for each of the one or more sentences of the electronic document based on the determined first score (depicted by 310). Based on the determined second score associated with each of the one or more sentences of the electronic document, the microprocessor 202 may determine the weight of each of the one or more sentences (depicted by 312). Further, the microprocessor 202 may determine the threshold value based on the mean of the first score associated with each pair of sentences (depicted by 314). The microprocessor 202 may further represent the one or more sentences as one or more nodes in a graph (depicted by 316). Further, the microprocessor 202 may add an edge between two nodes if the determined first score (between the sentences represented by the two nodes) is greater than or equal to the threshold value (depicted by 318).

Thereafter, the microprocessor 202 may identify the set of nodes from the one or more nodes by applying an algorithm for finding a minimum vertex cover of the graph (depicted by 320). Based on the identified set of nodes, the microprocessor 202 may create the summary of the electronic document (depicted by 322). Thereafter, the microprocessor 202 may transmit the summary of the electronic document to the display screen 210 (depicted by 324). The display screen 210 may display the summary to the user through a user interface associated with the application server 104 (depicted by 326). In another scenario, the microprocessor 202 may transmit the summary to the user-computing device 102 (not shown in FIG. 3). The user-computing device 102 may then display the summary to the user on the display screen 210 of the user-computing device 102.

In a scenario, where the NLP segregates each of the one or more sentences in the one or more segments, the microprocessor 202 may determine the first score for each pair of the one or more segments. Thereafter, the microprocessor 202 may follow the same steps as discussed above to create the summary of the electronic document.

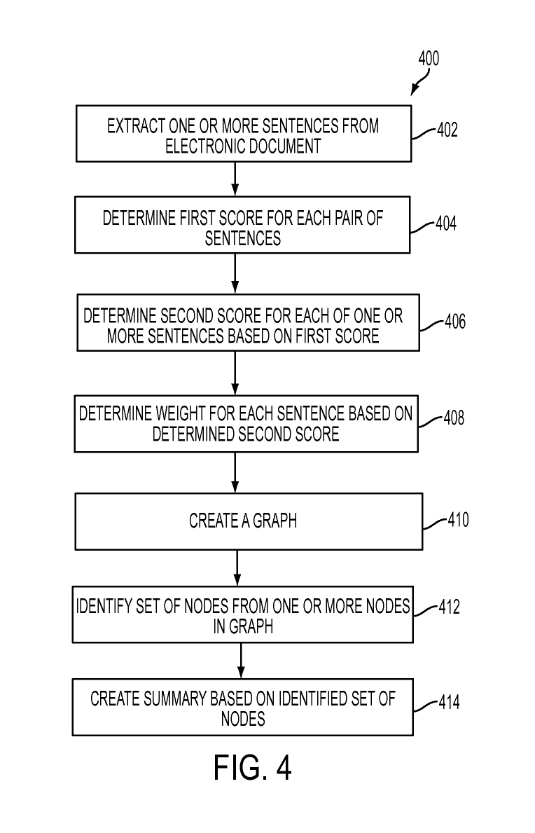

FIG. 4 is a flowchart 400 illustrating a method for summarizing an electronic document, in accordance with at least one embodiment. The flowchart 400 has been described in conjunction with FIG. 1 and FIG. 2.

At step 402, the one or more sentences are extracted from the electronic document. In an embodiment, the NLP 206 is configured to extract the one or more sentences from the electronic document. In an embodiment, prior to extracting the one or more sentences from the electronic document, the transceiver 212 may receive the document from the user-computing device 102. Thereafter, the transceiver 212 may send the document to the NLP 206 for analysis. In an embodiment, the NLP 206 may utilize one or more machine learning techniques or one or more natural language processing techniques to analyze the electronic document. Based on the analysis, in an embodiment, the NLP 206 may extract the one or more sentences from the electronic document that may be utilized to create the summary of the electronic document. In an embodiment, the NLP 206 may identify a sentence based on the identification of predetermined characters such as a full stop (i.e., “.”). For example, if there is an electronic document d for which summary is to be generated, the NLP 206 extracts one or more sentences from the electronic document d. Further, the NLP 206 may store the extracted one or more sentences of the electronic document d in the form of an array D (1×N) in the memory 204. Here, N refers to the number of extracted sentences. The following table illustrates the example of representing extracted one or more sentences of electronic document:

TABLE 1
Representation of extracted sentences

| Electronic | |
|---|---|
| Document | |
| (d) | Sentence |
| S1 | A representative of the African National Congress said |
| | Saturday the South African government may release black |
| | nationalist leader Nelson Mandela as early as Tuesday |
| S2 | “There are very strong rumors in South Africa today that |
| | on Nov. 15 Nelson Mandela will be released,” said Yusef |
| | Saloojee, chief representative in Canada for the ANC, which |
| | is fighting to end white-minority rule in South Africa. |
| S3 | Mandela the 70-year-old leader of the ANC jailed 27 years |
| | ago, was sentenced to life in prison for conspiring to |
| | overthrow the South African government. |
| S4 | He was transferred from prison to a hospital in August for |
| | treatment of tuberculosis. |
| S5 | A South African government source last week indicated |
| | recent rumors of Mandela's impending release were |
| | orchestrated by members of the anti-apartheid movement to |
| | pressure the government into taking some action. |
| S6 | Apartheid is South Africa's policy of racial separation. |

It can be observed from the Table 1 that the one or more sentences (i.e., S1 to S6), extracted from the electronic document d. For example, as shown in the Table 1, the NLP 206 extracts 6 sentences from the electronic document d. It will be apparent to a person having ordinary skill in the art that the sentences in the Table 1 have been provided for illustration purposes and should not limit the scope of the disclosure.

A person skilled in the art would appreciate that any known technique may be used to extract the one or more sentences from the electronic document, without departing from the scope of the disclosure.

At step 404, the first score for each pair of sentences is determined. In an embodiment, the microprocessor 202 may determine the first score for every pair of sentences of the electronic document. In an embodiment, prior to determining the first score, the microprocessor 202 may form pairs of each of the one or more sentences. For instance, referring to the Table 1, the microprocessor 202 may form 36 pairs for sentences (6×6). Thereafter, the microprocessor 202 may determine the first score for each of the 36 pairs of sentences. In an embodiment, the first score may correspond to a measure of an entailment between the sentences in the pair of sentences. The entailment between the sentences in the pair of sentences of the electronic document may depict a degree to which a sentence, in the pair of sentences, can be entailed or implied from the other sentence in the pair of sentences.

A person having ordinary skill in the art would understand that there may exist a possibility that a first sentence may be entailed by a second sentence, however, the second sentence may not be entailed by the first sentence. That is, the first sentence may be implied from the second sentence, however, the vice versa may not be true. Therefore, in such a scenario, the entailment score between the first sentence and the second sentence may not be zero, however, the entailment score between the second sentence and the first sentence may be zero. Hereinafter, the first score has been referred to as a textual entailment score, TE score. In an embodiment, the microprocessor 202 may determine the first score by using a textual entailment algorithm. For example, as shown in the table 1, the microprocessor 202 determines the first score for every pair of the extracted sentences (i.e., the 6 sentences S1-S6) of the electronic document d by applying the textual entailment algorithm. In an embodiment, the microprocessor 202 may further store the first score for each pair of sentences of the electronic document d in a sentence entailment matrix, SE (N×N). The following table illustrates the first score for every pair of sentences in the electronic document:

TABLE 2
Illustration of the first score for every pair of sentences.

| | S1 | S2 | S3 | S4 | S5 | S6 |
|---|---|---|---|---|---|---|
| S1 | — | 0 | 0 | 0.04 | 0.001 | 0.02 |
| S2 | 0.02 | — | 0.01 | 0.04 | 0 | 0.04 |
| S3 | 0 | 0 | — | 0.09 | 0 | 0.04 |
| S4 | 0 | 0 | 0 | — | 0 | 0.01 |
| S5 | 0 | 0 | 0 | 0.04 | — | 0.27 |
| S6 | 0 | 0 | 0 | 0.04 | 0 | — |

It can be observed from the Table 2 that the microprocessor 202 determines the first score for each pair of sentences in the electronic document. For example, the first score between the sentences 51 and S2 is 0. However, the first score between the sentences S2 and 51 is 0.02. Therefore, implying or deriving S2 from S1 is not possible, however, the vice versa may be true. Similarly, the first score between the sentences S1 and S4 is 0.04. Further, the microprocessor 202 stores the first score for each pair of sentences of the electronic document in the sentence entailment matrix, SE (N×N). In an embodiment, each entry in the sentence entailment matrix may be represented as SE [i,j]. In an embodiment, an entry SE [i,j] in the sentence entailment matrix may represent the extent by which a sentence ‘i’ entails the sentence ‘j’ in the electronic document, d. For example, an entry SE [1,4] represents that the sentence S1 entails the sentence S4 by 0.04. Similarly, the entry SE [1,5] represents that the sentence S1 entails the sentence S5 by 0.001.

It will be apparent to a person having ordinary skill in the art that data in the Table 2 has been provided for illustration purposes and should not limit the scope of the disclosure.

Further, a person skilled in the art would appreciate that any known technique may be used to determine the first score for each pair of sentences in the electronic document, without departing from the scope of the disclosure.

At step 406, the second score for each of the one or more sentences is determined. In an embodiment, the microprocessor 202 may determine the second score for each of the one or more sentences of the electronic document based on the first score associated with each pair of sentences. In an embodiment, the second score may represent a measure of connectivity of a sentence with other sentences in the electronic document. The connectivity of a sentence corresponds to a degree by which the sentence entails all other sentences in the electronic document. In an embodiment, the second score may correspond to a connectivity score. In an embodiment, the microprocessor 202 may utilize the following equation to determine the second score for each sentence:

ConnScore[i]=Σ_{i≠j}SE[i,j] (1)

where,

SE [i,j]: An entry in the Sentence Entailment Matrix that represents sentence i entails sentence j.

For example, in an embodiment, the microprocessor 202 may apply the aforementioned equation (i.e., equation 1) on the sentence entailment matrix represented in Table 2 to determine the second score for each of the one or more sentences in the electronic document. The following table illustrates the second score for each of the one or more sentences in the electronic document:

TABLE 3
Illustration of the second score for each sentence.

| Electronic Document (d) | Second Score |
|---|---|
| S1 | 0.061 |
| S2 | 0.11 |
| S3 | 0.13 |
| S4 | 0.01 |
| S5 | 0.31 |
| S6 | 0.04 |

As shown in Table 3, the microprocessor 202 determines the second score for each of the one or more sentences (i.e., S1 to S6) by applying equation 1. For example, the microprocessor 202 determines the second score for sentence S1 by summing the first score of the sentence S1 with other 5 sentences of the electronic document. Therefore, the second score for sentence S1 is 0.061. Similarly, the second score for sentence S2 is 0.11.

It will be apparent to a person having ordinary skill in the art that data in the Table 3 has been provided for illustration purposes and should not limit the scope of the disclosure.

At step 408, the weight for each of the one or more sentences is determined. In an embodiment, the microprocessor 202 may determine the weight of each of the one or more sentences in the electronic document. The weight for each of the one or more sentences may be determined based on the second score associated with each of the one or more sentences. In an embodiment, the microprocessor 202 may determine the weights in such a manner that the second score remains positive. The microprocessor 202 may utilize the following equation to determine the weights:

w[i]=−ConnScore[i]+Z (2)

where,

w[i]=Weight for sentence i,

Z=Constant,

ConnScore[i]=Connectivity Score for sentence i.

In an embodiment, the microprocessor 202 may determine Z in such a way that the weights should be positive. Further, Z should be larger than any of the connectivity scores of the one or more sentences. For example, from the Table 3, the second score of the sentence S1 is 0.061. The microprocessor 202 may consider constant ‘Z’ as 100 in order to convert the second score into positive weights in an inverted order. Thereafter, the microprocessor 202 may utilize the aforementioned equation 2 to determine the weight for the sentence S1 (i.e., 99.939). Similarly, the microprocessor 202 determines the weight for each of the one or more sentences (i.e., 6 sentences) in the document as explained above.

At step 410, a graph is created. In an embodiment, the microprocessor 202 may be configured to create the graph. In an embodiment, the graph may include one or more nodes representing the one or more sentences. Further, an edge is added between a pair of sentences. In an embodiment, the microprocessor 202 may add an edge between the pair of sentences in the graph. Prior to adding the edges, the microprocessor 202 may determine a threshold value. In an embodiment, the threshold value is a mean of the first score associated with each pair of sentences.

For example, in an embodiment, the microprocessor 202 determines the threshold value by taking the mean of the first score in the sentence entailment matrix illustrated in Table 2 as 0.01836.

Post determining the threshold value, the microprocessor 202 may add an edge between the pair of sentences. For example, in an embodiment, the graph G has vertices (V) and edges (E), the microprocessor 202 may add an edge (i, j) to the graph, G if the SE [i,j] is greater than or equal to the threshold value, represented hereinafter as τ. In another embodiment, the microprocessor 202 may add an edge to the graph, G if the SE [j,i] is greater than or equal to the threshold value, τ. In an embodiment, the microprocessor 202 may utilize the following equations to determine whether to add an edge or not:

SE[i,j]≧τ (3)

SE[j,i]≧τ (4)

A person having ordinary skill in the art would understand that the microprocessor 202 may add an edge between the two nodes if any of the condition (in equations 3 and 4) is satisfied. In an alternate embodiment, the microprocessor 202 may add an edge between the two nodes only if both the conditions are satisfied.

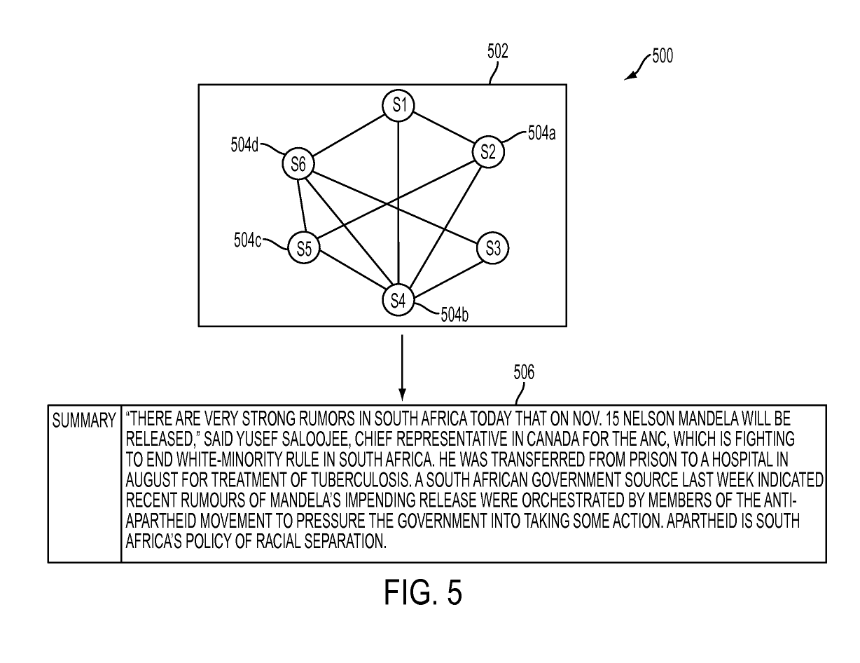

For example, as determined above, the threshold value is 0.01836. Further, the first score between S1 and S4 is 0.04. The microprocessor 202 utilizes the equation 3 to determine whether SE [1,4] is greater than or equal to the threshold value. Since, the value 0.04 is greater than the 0.01836, therefore, the microprocessor 202 adds an edge between the S1 and S4. Similarly, the microprocessor 202 repeats the same process for each pair of sentences in the document, which results in the creation of the graph. The creation of the graph has been described later in conjunction with FIG. 5.

In an embodiment, the microprocessor 202 may receive an input from the user associated with the user-computing device 102. The input may indicate a word limit for the required summary of the electronic document. Based on the specified word limit of the summary, the microprocessor 202 may determine the threshold value in the same manner as discussed above.

At step 412, a set of nodes from the one or more nodes in the graph are identified. In an embodiment, the microprocessor 202 may identify the set of nodes from the one or more nodes. The set of nodes are identified from the one or more nodes by applying a weighted minimum vertex cover (MVC) algorithm on the graph. For example, the graph generated at step 410 is a weighted graph, G=(V, E, w), where, V, E, w correspond to vertices, edges, and weights respectively. The microprocessor 202 may apply the minimum vertex cover algorithm on the weighted graph (G) to determine the weighted minimum vertex cover. In an embodiment, the weighted minimum vertex cover may represent the identified set of nodes from the one or more nodes. For example, the weighted minimum vertex cover of G is a subset of the vertices, C [symbol] V, such that for every edge (u, v)εE either uεC or vεC (or both). In an embodiment, the weighted minimum vertex cover of G is a subset of the vertices, C [symbol] V, such that the total sum of the weights may be minimized. Further, in an embodiment, the microprocessor 202 may utilize the following equation to determine the minimum vertex cover:

C=argmin_{C′}Σ_{vεC},w(v) (5)

where,

w(v)=weight on the vertices, w: V→R,

C=Minimum vertex Cover.

In an embodiment, the set of nodes are selected in such a manner that all the edges in the graph may either originate or end at the selected set of nodes. Further, the selected set of nodes must satisfy the equation 5. Thereafter, the minimum vertex cover algorithm may be utilized by the microprocessor 202 in such a way that the sum of the weights assigned to the identified set of nodes is minimum among all the possibilities of the set of nodes. A person having ordinary skill in the art would understand that there may exist a numerous number of possibilities in which the set of nodes may be identified that may cover each of the one or more edges. Further, the microprocessor 202 may identify only those sets of nodes that has minimum weight among all other possibilities (i.e., equation 5).

In an embodiment, the minimum vertex cover algorithm has been described later in conjunction with FIG. 5. In an embodiment, the microprocessor 202 utilizes the equation 5 to determine the minimum vertex cover. The minimum vertex cover represents the set of sentences identified from the one or more sentences of the electronic document. For example, the microprocessor 202 applies the minimum vertex cover algorithm on the created graph, as discussed above. Further, the microprocessor 202 identifies the set of nodes from the one or more nodes. The one or more nodes may represent one or more sentences of the electronic document, d, as shown in the table 1. For example, the identified set of sentences from the Table 1 is S2, S4, S5, and S6. The identified set of sentences has been further described in conjunction with FIG. 5.

It will be apparent to a person having ordinary skill in the art that the above-mentioned algorithms for identifying the set of nodes have been provided for illustration purposes and should not limit the scope of the disclosure. For example, in an embodiment, the microprocessor 202 may employ different algorithms such as integer linear programming (polynomial-time algorithm) to identify the set of nodes, without departing from the scope of the disclosure.

At step 414, a summary is created. In an embodiment, the microprocessor 202 may create the summary of the electronic document based on the identified set of nodes. The sentences associated with the identified set of nodes may be utilized to create the summary of the electronic document. For example, as determined in the step 412, the microprocessor 202 identifies sentences S2, S4, S5, and S6. Further, the microprocessor 202 utilizes the identified sentences S2, S4, S5, and S6 to create the summary of the electronic document. The summary of the electronic document is “There are very strong rumors in South Africa today that on November 15 Nelson Mandela will be released,” said Yusef Saloojee, chief representative in Canada for the ANC, which is fighting to end white-minority rule in South Africa. He was transferred from prison to a hospital in August for treatment of tuberculosis. A South African government source last week indicated recent rumors of Mandela's impending release were orchestrated by members of the anti-apartheid movement to pressure the government into taking some action. Apartheid is South Africa's policy of racial separation”. The creation of summary may be further described later in conjunction with the FIG. 5.

In an embodiment, the sentences in the summary may be arranged based on the spatial occurrence of the sentences in the electronic document. For example, if occurrence of sentence S1 precedes the occurrence of the sentence S2. Thus, in the summary also the sentence S1 may precede the sentence S2.

In a scenario, where the word limit is provided by the user through the user-computing device 102, the microprocessor may determine the threshold value based on the word limit. As the threshold value may be deterministic of the edges being placed between two nodes, therefore, the selection of the set of nodes using the minimum vertex algorithm may vary based on the word limit. Hence, the summary so created may be in accordance to the word limit.

FIG. 5 is a graph 500 illustrating a method for creating the summary of the electronic document, in accordance with at least one embodiment. The graph 500 has been described in conjunction with the FIG. 1, FIG. 2, and FIG. 4.

As shown in the FIG. 5, the graph is created (depicted by 502). The microprocessor 202 creates the graph 502 based on the first score associated with each pair of sentences, as determined above. The graph 502 may include one or more nodes representing one or more sentences (i.e., S1 to S6), as shown in the Table 1. Further, the microprocessor 202 identifies the set of nodes (depicted by 504) from the one or more nodes by using the equation 5, as determined above. The set of nodes representing one or more sentences are S2, S4, S5, and S6 (depicted by 504a, 504b, 504c, and 504d). Based on the identified set of nodes, the microprocessor 202 creates the summary of the electronic document (depicted by 506).

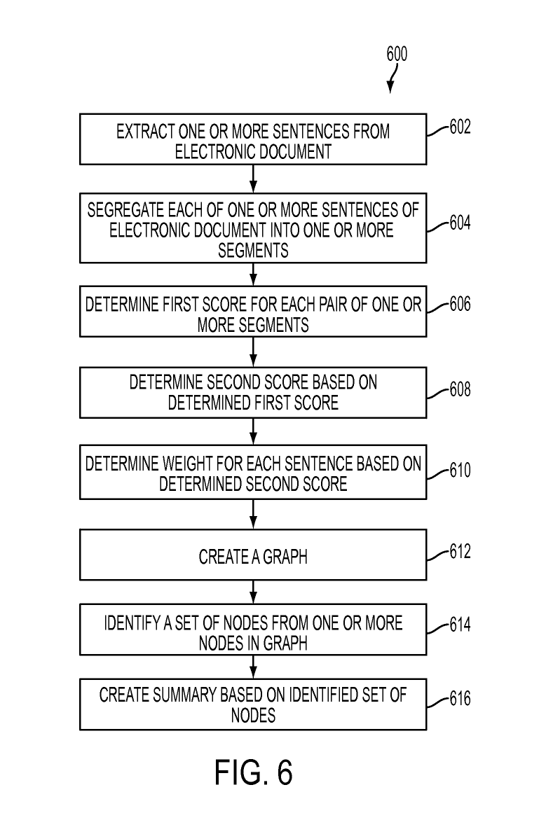

FIG. 6 is another flowchart 600 illustrating another method for summarizing an electronic document, in accordance with at least one embodiment. The flowchart 600 has been described in conjunction with FIG. 1, FIG. 2, and FIG. 4.

In certain scenarios, the microprocessor 202 may observe that the textual entailment may not provide a reliable score for each of the one or more sentences in the electronic document. Further, the microprocessor 202 may not be able to determine the textual entailment properly. Therefore, in order to overcome this type of scenario, the NLP 206 may segregate one or more sentences into one or more segments.

At step 602, the one or more sentences are extracted from the electronic document. In an embodiment, the NLP 206 is configured to extract the one or more sentences from the electronic document by utilizing one or more machine learning techniques or one or more natural language processing techniques, as discussed above in the step 402.

At step 604, each of the one or more sentences of the electronic document is segregated into one or more segments. In an embodiment, the NLP 206 may segregate the one or more sentences into the one or more segments. The segregation is performed based at least on one or more rules. The one or more rules may include, but are not limited to, redact interrogative sentences, sentences with conjugation words, or sentences with examples.

In an embodiment, the NLP 206 may segregate the interrogative sentences. The interrogative sentences may be segregated by removing part of sentence prior to words indicating utterances. In an embodiment, the part of sentence prior to such words may include, but are not limited to, “asked”, “said”, “replied”, or “answered”. Further, in an embodiment, the NLP 206 may keep the part of sentences after these words. For example, a sentence, “He asked me ‘where was Ram the night before?”’. The NLP 206 may segregate the sentence by discarding “He asked me” and keeping “Where was Ram the night before”.

In another embodiment, the NLP 206 may segregate the sentences with conjugation words. The conjugation words may include, but are not limited to, “likewise”, “or”, “nor”, “and”, etc. In an embodiment, the NLP 206 may segregate the sentences into two segments by removing the conjugation words. For example, a sentence “Mary went to the park, and John went to the beach”. The NLP 206 may segregate the sentence into two segments “Mary went to the park” and “John went to the beach” by removing conjugation word “and”.

In another embodiment, the NLP 206 may segregate the sentences with examples. The sentences with examples may include, but are not limited to, words such as, “for example”, “except”, “specially”, “especially”, or “specifically”. The NLP 206 may segregate the sentences with examples by removing these words.

It will be apparent to a person having ordinary skill in the art that the aforementioned rules for segregating the sentences have been provided for illustration purposes and should not limit the scope of the disclosure. For example, in an embodiment, the microprocessor 202 may employ different rules to segregate the sentences, without departing from the scope of the disclosure.

At step 606, the first score for each pair of the one or more segments is determined. In an embodiment, the microprocessor 202 may determine the first score for each pair of the one or more segments by utilizing a textual entailment algorithm. The first score may correspond to a measure of entailment between the segments included in the each pair of the one or more segments. Thereafter, the microprocessor 202 may store the first score for each pair of segments in a similar manner as discussed in the step 404.

At step 608, the second score for each of the one or more sentences is determined. In an embodiment, the microprocessor 202 may determine the second score for each of the one or more sentences of the electronic document based on the first score. The second score for a sentence may be determined by summing the first scores associated with the segments that were extracted from the sentence under consideration. For example, if two segments were segregated from the sentence, the second score of the sentence will be the sum of first score associated with both the segments. In an embodiment, the second score may represent a measure of connectivity of a sentence with other sentences, as discussed in the step 406.

Thereafter, steps 610-616 may be performed in a manner similar to the steps 408-414 respective, explained in conjunction with the FIG. 4.

The disclosed embodiments encompass numerous advantages. Through various embodiments for summarizing an electronic document, it is disclosed that a graph may be created to determine a degree of connectivity between one or more sentences of the electronic document. For example, if two sentences in the document are highly connected (as determined based on the degree of connectivity of the two sentences), one of the sentences may be omitted from the summary of the document without compromising on the context of the document. Further, the disclosure uses a threshold value to add an edge between pair of sentences in the graph, which would then be used to create the summary. The threshold value may ensure that the sentences added in the summary contribute to the context of the document.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for summarizing electronic documents have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for summarizing an electronic document, said method comprising:
extracting, by a natural language processor, one or more sentences from said electronic document;
creating, by one or more microprocessors, a graph, comprising one or more nodes and one or more edges connecting said one or more nodes, each node being representative of a sentence from said one or more sentences, wherein an edge is placed between a pair of sentences based on a threshold value and a first score, wherein said first score corresponds to a measure of an entailment between said pair of sentences; and
identifying, by said one or more microprocessors, a set of nodes from said one or more nodes by applying a minimum vertex cover algorithm on said graph, wherein sentences associated with said identified set of nodes are utilizable to create a summary of said electronic document.

2. The method of claim 1, wherein said first score is determined by utilizing a textual entailment algorithm.

3. The method of claim 2 further comprising determining, by said one or more microprocessors, a second score for each of said one or more sentences based on said first score, wherein said second score is representative of a measure of connectivity of a sentences with other sentences.

4. The method of claim 3 further comprising determining, by said one or more microprocessors, a weight of each of the one or more sentences based on said determined second score associated with each of said one or more sentences.

5. The method of claim 1, wherein said threshold value is determined based at least on a mean of said first score associated with said each pair of sentences.

6. The method of claim 1 further comprising receiving an input indicative of a word limit of said summary.

7. The method of claim 6, wherein said threshold value is determined based on said specified word limit of said summary.

8. The method of claim 1 further comprising displaying, on a display screen, said summary through a user interface.

9. A method for summarizing an electronic document, said method comprising:
extracting, by a natural language processor, one or more sentences from said electronic document;
segregating, by said natural language processor, said one or more sentences into one or more segments;
determining, by one or more microprocessors, a first score between each pair of said one or more segments by utilizing a textual entailment algorithm, wherein said first score corresponds to a measure of entailment between each pair of said one or more segments;
determining, by said one or more microprocessors, a second score for each of said one or more sentences based on said determined first score of said one or more segments, respectively;
creating, by said one or more microprocessors, a graph, comprising one or more nodes and one or more edges connecting said one or more nodes, each node being representative of a sentence from said one or more sentences, wherein an edge is placed between a pair of sentences based on a threshold value and said first score associated with said pair of segments, wherein said threshold value is determined based on said second score associated with each of said one or more sentences; and
identifying, by said one or more microprocessors, a set of nodes from said one or more nodes by applying a minimum vertex cover algorithm on said graph, wherein sentences associated with said identified set of nodes are utilizable to create a summary of said electronic document.

10. The method of claim 9 further comprising determining, by said one or more microprocessors, a weight for each of said one or more sentences based on said determined second score associated with each of said one or more sentences.

11. The method of claim 9, wherein said segregation is performed based on one or more rules.

12. The method of claim 11, wherein said one or more rules comprises at least by redacting interrogative sentences, sentences with conjugation words, or sentences with examples.

13. A system for summarizing an electronic document, said system comprising:
a natural language processor configured to extract one or more sentences from said electronic document;
one or more microprocessors configured to:
create a graph, comprising one or more nodes and one or more edges connecting said one or more nodes, each node being representative of a sentence, wherein an edge is placed between a pair of sentences based on a threshold value and a first score, wherein said first score corresponds to a measure of an entailment between said pair of sentences; and
identify a set of nodes from said one or more nodes by applying a minimum vertex cover algorithm on said graph, wherein sentences associated with said identified set of nodes are utilizable to create a summary of said electronic document.

14. The system of claim 13, wherein said first score is determined by utilizing a textual entailment algorithm.

15. The system of claim 13, wherein said one or more microprocessors are further configured to determine a second score for each of said one or more sentences based on said first score, wherein said second score is representative of a measure of connectivity of a sentence with other sentences.

16. The system of claim 15, wherein said one or more microprocessors are further configured to determine a weight of each of said one or more sentences based on said determined second score associated with each of said one or more sentences.

17. The system of claim 13, wherein said threshold value is determined based at least on a mean of said first score associated with said each pair of sentences.

18. The system of claim 13, wherein a display screen is configured to display said summary on a user interface.

19. The system of claim 13, wherein said natural language processor is further configured to segregate said one or more sentences into one or more segments.

20. The system of claim 19, wherein said one or more microprocessors are further configured to determine said first score between each pair of said one or more segments.

21. A system for summarizing an electronic document, said system comprising:
a natural language processor configured to:
extract one or more sentences from said electronic document;
segregate said one or more sentences into one or more segments;
one or more microprocessors configured to:
determine a first score between each pair of said one or more segments by utilizing a textual entailment algorithm, wherein said first score corresponds to a measure of entailment between each pair of said one or more segments;
determine a second score for each of said one or more sentences based on said determined first score of said one or more segments, respectively;
create a graph, comprising one or more nodes and one or more edges connecting said one or more nodes, each node being representative of a sentence from said one or more sentences, wherein an edge is placed between a pair of sentences based on a threshold value and said first score associated with said pair of segments, wherein said threshold value is determined based on said second score associated with each of said one or more sentences; and
identify a set of nodes from said one or more nodes by applying a minimum vertex cover algorithm on said graph, wherein sentences associated with said identified set of nodes are utilizable to create a summary of said electronic document.

22. The system of claim 21, wherein said one or more microprocessors are further configured to determine a weight for each of said one or more sentences based on said determined second score associated with each of said one or more sentences.

23. The system of claim 21, wherein said segregation is performed based on one or more rules.

24. The system of claim 23, wherein said one or more rules comprises at least by redacting interrogative sentences, sentences with conjugation words, or sentences with examples.

25. A computer program product for use with a computer, the computer program product comprising a non-transitory computer readable medium, wherein the non-transitory computer readable medium stores a computer program code for summarizing an electronic document, wherein the computer program code is executable by one or more microprocessors to:
extract, by a natural language processor, one or more sentences from said electronic document;
create, by one or more microprocessors, a graph, comprising one or more nodes and one or more edges connecting said one or more nodes, each node being representative of a sentence from said one or more sentences, wherein an edge is placed between a pair of sentences based on a threshold value and a first score, wherein said first score corresponds to a measure of an entailment between said pair of sentences; and
identify, by said one or more microprocessors, a set of nodes from said one or more nodes by applying a minimum vertex cover algorithm on said graph, wherein said sentences associated with said identified set of nodes are utilizable to create a summary of said electronic document.

26. A computer program product for use with a computer, the computer program product comprising a non-transitory computer readable medium, wherein the non-transitory computer readable medium stores a computer program code for summarizing an electronic document, wherein the computer program code is executable by one or more microprocessors to:
extract, by a natural language processor, one or more sentences from said electronic document;
segregate, by said natural language processor, said one or more sentences into one or more segments;
determine, by one or more microprocessors, a first score between each pair of said one or more segments by utilizing a textual entailment algorithm, wherein said first score corresponds to a measure of entailment between each pair of said one or more segments;
determine, by said one or more microprocessors, a second score for each of said one or more sentences based on said determined first score of said one or more segments, respectively;
create, by said one or more microprocessors, a graph, comprising one or more nodes and one or more edges connecting said one or more nodes, each node being representative of a sentence from said one or more sentences, wherein an edge is placed between a pair of sentences based on a threshold value and said first score associated with said pair of segments, wherein said threshold value is determined based on said second score associated with each of said one or more sentences; and
identify, by said one or more microprocessors, a set of nodes from said one or more nodes by applying a minimum vertex cover algorithm on said graph, wherein sentences associated with said identified set of nodes are utilizable to create a summary of said document.
